(19) United States
(12) Patent Application Publication
(10) Pub. No.: US 2017/0217156 A1
(43) Pub. Date: Aug. 3, 2017

(54) PRINTING FACILITY AND METHOD FOR SLEEVES ARRANGEMENT IN SAID PRINTING FACILITY

(71) Applicant: COMEXI GROUP INDUSTRIES, S.A.U, Riudellots de la Selva (ES)

(72) Inventors: Jordi PUIG VILÀ, Bescano (ES); Jordi SOLÀ FERRÉS, Olot (ES)

(21) Appl. No.: 15/416,047

(22) Filed: Jan. 26, 2017

(30) Foreign Application Priority Data
Jan. 29, 2016 (EP) 16153305.4

(51) Int. Cl. B41F 30/02; B41N 6/00

(52) U.S. Cl. CPC B41F 30/02; B41N 6/00

(57) ABSTRACT

Printing facility for the manipulation of a plurality of sleeve assemblies (52) each composed by a printing sleeve (50) having a cylindrical internal surface (61) with a diameter larger than the diameter of a printing shaft (12) and an independent tubular cylindrical intermediate sleeve (51) inserted into the cylindrical printing sleeve (50), said printing sleeve comprising a printing machine (10) comprising cylindrical printing shafts (12), and a robotic unit (20) comprising a sleeves handling device (21), the facility further comprising a first storage (30) for store a plurality of printing sleeves (50), which include retaining elements (31) for the immobilization of the stored printing sleeves (50) in geometrical interference with the printing cylindrical external surface (60) and/or with at least one of the annular faces (62) of the printing sleeves (50).

### RELATED APPLICATION

The present application claims priority to European Patent Application No. EP16153305.4 filed 29 Jan. 2016 and entitled Printing Facility and Method for Sleeves Arrangement in said Printing Facility, the contents of which are hereby incorporated by reference as if set forth in their entirety.

### TECHNICAL FIELD

The present invention relates to a printing facility and method for sleeves arrangement in said printing facility using a robot.

The invention is implemented in a printing facility including a printing machine comprising a central drum and a plurality of printing units, each printing unit integrating at least one printing shaft which provides a sleeve support, and a robotic unit comprising a sleeves handling device, said robotic unit being provided for printing sleeves manipulation, and for insertion and extraction of said sleeves assemblies from the printing shafts of the printing machine, for example in order to modify the impression pattern, and for insertion and extraction of said intermediate sleeves from the printing sleeves in collaboration with a first sleeves storage which immobilize the printing sleeves.

The invention is particular intended for the handling of tubular and cylindrical shaped sleeve assemblies each including an intermediate sleeve inserted into a printing sleeve.

### BACKGROUND

A printing facility for the manipulation of a plurality of tubular and cylindrical shaped printing sleeves, said printing facility including a printing machine and a robotic unit comprising a sleeves handling device, is already known for example through documents EP1705009 which describes an automatic handling and transport device for printing sleeves which enables performing printing sleeve changing operations in a flexographic printer while the flexographic printer is operating, said device comprising a sleeve handling shaft that can be positioned in alignment with a printing shaft and in proximity with same and a handling device carriage configured for being moved along the sleeve handling shaft in order to extract/insert a printing sleeve from/to the printing shaft of the printing machine.

Patent EP1776231 also describes a system for the replacement of sleeves of a printing machine where there has been provided a basic mobile unit, consisting of a known programmable robotic manipulator with two rotational joints, and pushing means arranged both in the printing machine and in a holding support of said robotic manipulator in order to transfer said sleeves to and from said holding support by pushing means. To transfer printing sleeves, the printer is equipped with pushing devices, and the robotic manipulator lacks means for the extraction of the sleeves itself by means of pulling on them, this operation depending on the pushing devices of the printer.

Also document EP2857200 proposes an evolution of the described documents, proposing an improvement to solve misalignment problems.

For each single color of each image to be printed a specific printing sleeve has to be provided to the printing machine, and each printing sleeve is expensive and heavy (very difficult to manipulate by hand in many cases), and depending on the size of the image to be printed, the diameter of the external cylindrical printing surface of said printing sleeves changes. Therefore many units of printing sleeves with different printing cylindrical surfaces diameters are needed. In order to reduce the stock of printing sleeves, to make them lighter (and therefore easy to be manipulated by hand if necessary) and to reduce also the total cost of the printing sleeves, it is proposed to provide printing sleeves assemblies, each composed by an intermediate sleeve tightly inserted into a printing sleeve with a low thickness cylindrical wall. Each printing sleeve can have a printing cylindrical surface with its diameter adapted to the image to be printed, but with an internal cylindrical surface with a standardized diameter corresponding with a standardized diameter of the external cylindrical surface of the intermediate sleeve. This way a single intermediate sleeve can be used by many different printing sleeves.

This solution include advantages, but complicates the printing sleeves manipulation operations, and any of the above cited documents describe a facility adapted for the manipulation of the cited printing sleeves assemblies, and for coupling and decoupling of the cited printing sleeves and intermediate sleeves.

### SUMMARY

According a first aspect of the present invention, it concerns to a printing facility for the manipulation of a plurality of tubular and cylindrical shaped sleeves each including a cylindrical external surface, a cylindrical internal surface and two annular faces on two opposite ends, being both cylindrical surfaces concentrically with a sleeve axis, said printing facility comprising:
a printing machine comprising a central drum and a plurality of printing units, each printing unit integrating at least one printing shaft which provides a sleeve support for supporting said sleeves;
a robotic unit comprising a sleeves handling device suitable for handling said sleeves.

The term sleeve used in this description involves a group of sleeves including:
printing sleeves which cylindrical external surface is intended for printing and which internal cylindrical surface has a diameter providing a gap fitting with the printing shaft,
a sleeve assembly (exposed below); and
an intermediate sleeve (exposed below).

Said robotic unit can be any automatic transport device provided for extracting/inserting said sleeves from/to the different printing shafts of each printing unit of the printing machine, allowing an automatic setting of said printing machine changing the sleeves rapidly and safely.

The printing machine is a web material printing machine, for example a flexographic printing machine, offset printing machine, rotogravure printing machine.

The handling device of the robotic unit is a device provided for the interaction of the robotic unit with the sleeves to be manipulated. Examples of said handling device can be, with a non-limitative character, a handling shaft provided to receive the sleeve on it, or a gripping means provided to grip a handle connected to said sleeve in order to permit the extraction of the sleeve at least from the printing shaft. Preferably said gripping means can be combined with said handling shaft, being said gripping means slidably arranged along said handling shaft in order to push and pull the sleeve regarding the handling shaft producing its insertion or extraction.

Said robotic unit can be, with a non-limitative character, a displaceable carriage movable along a printing machine parallel to the printing machine side, and including said handling device movable in a vertical direction along a vertical guide connected to said displaceable carriage. According a different embodiment said robotic unit is an articulated arm with at least two segments articulated.

The disclosed invention further comprises in a printing facility:
sleeve assemblies each composed by a printing sleeve having a cylindrical internal surface with a diameter larger than the diameter of the shaft of said printing shaft and an independent tubular cylindrical intermediate sleeve tightly inserted into the cylindrical printing sleeve, said intermediate sleeve having an internal cylindrical surface providing a gap fitting with the printing shaft diameter, said intermediate sleeve having an external cylindrical surface with a diameter equal than the diameter of the printing sleeve internal surface, and two annular faces on two opposite ends, being all the cylindrical surfaces of the printing assembly concentrically with a sleeve axis and said sleeve supports being provided for coupling with the intermediate sleeve or with the printing sleeve assembly;
a first storage for storing a plurality of printing sleeves or a plurality of sleeves assemblies, said first storage being provided with a retaining elements for the immobilization of the printing sleeves stored on said printing sleeves storage in geometrical interference with the printing cylindrical external surface and/or with at least one of the annular faces of the printing sleeve, said retaining elements being disposed avoiding a geometrical interference with a displacement path in the sleeve axis direction of an intermediate sleeve to be extracted or to be inserted into the printing sleeve, being the printing sleeve stored on said printing sleeve storage.

It is understood that the gap fitting provided between the internal cylindrical surface of the intermediate sleeve and the printing shaft is achieved by providing said two elements with an equal nominal diameter, being the real diameter of the printing shaft slightly smaller than the real diameter of the internal cylindrical surface of the intermediate sleeve, according to acceptable tolerances, in order to enable a smooth insertion and extraction of said printing shaft into said internal cylindrical surface. Usually the printing shaft include fixing means to provide a safe coupling to said internal cylindrical surface, for example by hydraulic expansion.

Said sleeves assemblies allow the use of a limited number of intermediate sleeves in combination with a bigger number of printing sleeves, because each sleeve assembly only needs the intermediate sleeve inserted on the printing sleeve during the printing process but not during the storing time, therefore a small number of intermediate sleeves can be used to be combined with a big number of printing sleeves, saving material and money, and creating a light printing sleeves which can be manipulated by hand if necessary, creating a printing sleeves with a thin cylindrical wall.

Additionally, the external printing cylindrical surface of the printing sleeves do not have a standard diameter, thus it depends on the size of the image to be printed, but the internal cylindrical surface of said printing sleeves can be standardized in order to standardize also the external diameter of the intermediate sleeves, so having one or a small number of intermediate sleeves diameters any external cylindrical printing surface diameter can be achieved combining said intermediate sleeves with the printing sleeves.

As previously indicated the first storage is a storage provided for storing the printing sleeves or even for storing the sleeves assemblies, regardless the external cylindrical printing surface diameter.

Said first storage immobilizes the printing sleeves or the printing sleeves of the sleeves assemblies stored on it at least through the geometrical interference of a retaining element with the external surfaces of said printing sleeves, i.e. the external cylindrical printing surface and/or the annular faces. The hollow empty internal space of the stored printing sleeves remains accessible from one of its ends, allowing the intermediate sleeve introduction.

In a different embodiment a printing sleeve assembly is stored on the printing sleeves store and immobilized through said retaining elements also in geometrical interference with the external surfaces of the printing sleeve member of the printing sleeve assembly. In this embodiment the intermediate sleeve member of the printing sleeve assembly can be freely extracted from the interior of the printing sleeve in a direction parallel to the sleeve axis, because the retaining elements do not face the annular face of the intermediate sleeve stored jointly with the printing sleeve, being the intermediate sleeve of the printing sleeves assemblies removable through one of the printing sleeve assemblies end thanks the non-interference of any first storage element with an extraction path of the intermediate sleeve parallel to the sleeve axis.

Said first storage is accessible for the robotic unit, in order to allow said robotic unit to store printing sleeves in said first storage or in order to pick up printing sleeves from said storage using said robotic unit, managing the printing sleeves and setting the printing machine.

During the operation of inserting or extracting the intermediate sleeve to/from the printing sleeve stored in the first storage, said printing sleeve should be immobilized in order to facilitate said operation. The retaining elements above described are elements of the first storage responsible for this immobilization task, and can be passive and static elements or active and dynamic elements.

The static and passive retaining elements will have no moving parts and will be positioned on the printing sleeve storage in such a way that any printing sleeve stored in said printing sleeve storage will become immobilized through the gravity and the geometrical interference with said retaining elements.

The dynamic and active retaining elements will include some moving parts either actively driven or either mechanisms activated by the interference with the printing sleeve stored. Said retaining element change its position to enter in interference with the external surfaces of the printing sleeve stored producing its immobilization.

The retaining element will produce the printing sleeve immobilization in the horizontal direction, opposed to the pushing or pulling force produced on the stored printing sleeve during its interaction with the robotic unit,

According an optional embodiment said first storage include for each printing sleeve at least two convergent support surfaces defining a concave support for retaining by gravity an external sleeve by geometrical interference with the printing cylindrical external surface of the printing sleeve whatever its diameter. For example two symmetric support surfaces each forming an angle of 45° regarding the vertical position.

The printing sleeve stored will be retained in vertical direction by the support surfaces and by gravity.

Said retaining elements will be defined, in a non-limitative embodiment, by at least a protrusion protruding from said concave support facing the annular surface of a printing sleeve stored on said concave support. This protrusion is a passive and static retaining element, and its high will not exceed the printing sleeve wall thickness, in order to avoid the geometrical interference of the retaining element with the insertion path of the intermediate sleeve.

Different retaining elements are also contemplated, for example an inflatable pillow pressing the external cylindrical printing surface of the stored printing sleeve or activated jaws surrounding said external cylindrical printing surface of the stored printing sleeve producing its immobilization, or protruding elements facing the annular face of the printing sleeve with adjustable high.

Alternative embodiments of the first storage are provided. For example for each stored printing sleeve the first storage can include at least a concave surface with a constant cross section along the length thereof for retaining by gravity a printing sleeve by geometrical interference with the printing cylindrical external surface of said printing sleeve whatever its diameter. Said concave surface can be for example an U-shaped channel or a hollow cylinder.

According to a different embodiment the first storage include, for each stored printing sleeve, at least two convex symmetric surfaces each with a constant cross section along the length thereof for retaining by gravity a printing sleeve by geometrical interference with the printing cylindrical external surface of said printing sleeve whatever its diameter. Said two convex symmetric surfaces can be to parallel cylinders.

An additional embodiment is provided, in which the robotic unit include a handling shaft in cantilever with a diameter equal or smaller than the printing shaft,

According to this embodiment, said handling shaft is provided to be introduced into the intermediate sleeve, thus its internal diameter provides a gap fitting with the handling shaft diameter, permitting to said handling shaft in cantilever to support the whole weight of the intermediate sleeve or the whole weight of the printing sleeve assembly during the handling operations performed by said robotic unit.

Said robotic unit is provided for the manipulation and transportation of an intermediate sleeve or a printing sleeve assembly, but a printing sleeve which internal cylindrical surface diameter is bigger than the printing shaft diameter cannot be handled or transported by said robotic unit, except integrated into a printing sleeve assembly.

In addition the handling device will include gripping means connected to a carriage which is slidably arranged on said handling shaft for a driven displacement along said handling shaft, producing the pushing or the pulling of the intermediate sleeve for the extraction or insertion of the handling shaft into said intermediate sleeve.

The robotic unit can also include at least a sensor for detecting the relative position between a free end of the handling shaft in cantilever above described and the printing shaft; or a stored intermediate sleeve, or a stored printing sleeve, or a stored printing sleeve assembly. This information can be used to achieve the precise position and alignment of the robotic unit regarding the other elements of the facility.

According to an alternative or an additional embodiment said handling shaft include a fixing device for the fixation of an intermediate sleeve supported on said handling shaft. Said fixing device produce the immobilization of the intermediate sleeve regarding the handling shaft, allowing the extraction of the intermediate sleeve from the printing sleeve pulling the handling shaft in the sleeve axis direction. Said fixing device can be, for example, an inflatable pillow or ring or a radial expander emplaced in said handling shaft.

In addition, it is disclosed that the facility includes a second storage which can store a plurality of intermediate sleeves, and/or a plurality of sleeve assemblies, each supported on a storage shaft, preferably a shaft with equal nominal diameter than the printing shaft. Said second storage will be accessible by the robotic unit.

The robotic unit includes air ducts provided for its connection with an intermediate sleeve supported by said robotic unit and for insufflating air into said intermediate sleeve through at least one air entrance, placed on one annular face of the intermediate sleeve. Said at least one air entrance is connected to a sleeve air ducts embedded on said intermediate sleeve, said sleeve air ducts being connected to a plurality of air exits placed on the external cylindrical surface of the intermediate sleeve. During the operation of inserting or extracting the intermediate sleeve to or from the printing sleeve, an air supply is insufflated from the air ducts of the robotic unit into the at least one air entrance of the intermediate sleeve, passing through the sleeve air ducts and exiting through said air exits. This air exiting from the air exits is injected into the interspace existing between the external cylindrical surface of the intermediate sleeve and at least part of the internal cylindrical surface of the printing sleeve, being the intermediate sleeve at least partially inserted into said printing sleeve. This air injected in said interspace produce an air interstitial laminar gap which facilitates a smooth displacement of the internal sleeve regarding the printing sleeve.

Optionally it is disclosed that the internal cylindrical surface of the printing sleeve is made by an elastic material, in such a way that the pressure of the air injected into said interspace deform said elastic material producing a slight increase of the diameter of the internal cylindrical surface of the printing sleeve. When the pressure of the air is removed both the intermediate printing sleeve and the printing sleeve become firmly coupled, by interference between the internal cylindrical surface of the printing sleeve and the external cylindrical surface of the intermediate sleeve.

According a second aspect of the invention, it also includes a method for sleeves arrangement in a printing facility, said sleeve being a plurality of tubular and cylindrical shaped sleeves each including a cylindrical external surface, a cylindrical internal surface and two annular faces on two opposite ends, being both cylindrical surfaces concentrically with a sleeve axis; and said printing facility comprising:
a printing machine comprising a central drum and a plurality of printing units, each printing unit integrating at least one printing shaft which provides a sleeve support;
a robotic unit comprising a sleeves handling device;

The method include following steps:
displacing the robotic unit, having an intermediate sleeve coupled to the sleeve handling device, to align an intermediate sleeve axis of said intermediate sleeve with the sleeve axis of a printing sleeve stored on a printing sleeve storage;
   said printing sleeve having a cylindrical internal surface which diameter is bigger than the printing shaft diameter;
   said intermediate sleeve having an internal cylindrical surface providing a gap fitting with the printing shaft, an external cylindrical surface with a diameter equal than the diameter of the printing sleeve internal cylindrical surface of the stored printing sleeve and two annular faces on two opposite ends, being both cylindrical surfaces concentrically with said intermediate sleeve axis;
   said printing sleeve being immobilized in the first storage through a retaining elements in geometrical interference with the printing cylindrical external surface and/or with at least one of the annular faces of the printing sleeve;
producing an insertion of the intermediate sleeve coupled to the sleeve handling device into the printing sleeve stored on the first storage through the intermediate sleeve displacement along an insertion path parallel to the sleeve axis through the robotic unit activation, achieving a complete insertion of the intermediate sleeve into the printing sleeve obtaining a printing assembly.

According to this method, the robot unit carries an intermediate sleeve, and positions said intermediate sleeve with its axis aligned with the axis of a printing sleeve stored on the first storage. After that the robot unit activation produces the displacement of the intermediate sleeve in an insertion path parallel to the sleeve axis direction, producing the insertion of the intermediate sleeve into the printing sleeve stored and immobilized in the first storage. The intermediate sleeve tight inserted into de printing sleeve produces a printing sleeve assembly.

According an additional embodiment, said robotic unit include a handling shaft in cantilever with a diameter equal or smaller than the printing shaft diameter, wherein said step of displacing the robotic unit having an intermediate sleeve coupled to the sleeve handling device to align an intermediate sleeve axis of said intermediate sleeve with the sleeve axis of a printing sleeve stored on a printing sleeve storage include:
placing said handling shaft of the robotic unit aligned with the sleeve axis of the printing sleeve stored on the first storage, being the cantilevered end of the handling shaft adjacent to the annular face of the printing sleeve stored;
   and wherein said step produce an insertion of the intermediate sleeve coupled to the sleeve handling device into the printing sleeve stored on the printing sleeve storage include:
insert said handling shaft of the robotic unit, and the intermediate sleeve carried on said handling shaft, into the stored printing sleeve internal cylindrical surface through the robotic unit displacement along an insertion path parallel to the sleeve axis; or
insert said intermediate sleeve carried on said handling shaft into the stored printing sleeve internal cylindrical surface through the driven displacement along said handling shaft of a handling device carriage slidably arranged on said handling shaft, pushing the intermediate sleeve into the stored printing sleeve and also producing the extraction of the handling shaft from the intermediate sleeve.

Additionally, after the insertion step, the printing assembly can be extracted from the printing sleeve storage through the robotic unit activation, releasing the printing cylindrical external surface of the printing unit from the geometrical interference with the retaining elements of the first storage. For example, producing a vertical elevation of the printing sleeve assembly and distancing it from a support surface and from the retaining elements which can be, for example, a protruding element.

It is also provided that the intermediate sleeve, coupled to the handling device, has been coupled to said handling device with a method selected among:
emplacing an empty handling device adjacent to an intermediate sleeve stored in a sleeves storage, coupling the handling device with the intermediate sleeve and extracting the intermediate sleeve from the sleeve storage; or
emplacing a sleeve assembly coupled to a handling device in a printing sleeve storage being the printing sleeve immobilized in the first storage through said retaining elements in geometrical interference whit the printing cylindrical external surface and/or with at least one of the annular faces of the printing sleeve, and produce the extraction of the intermediate sleeve coupled to the sleeve handling device from the printing sleeve retained on the printing sleeve storage through the intermediate sleeve displacement along an extraction path parallel to the sleeve axis through the robotic unit activation.

According a third aspect of the present invention concerning to an additional alternative printing sleeves manipulation method, it concerns to a method for printing sleeves arrangement in a printing facility, said printing sleeves being a plurality of tubular and cylindrical shaped printing sleeves each including a printing cylindrical external surface, a cylindrical internal surface and two annular faces on two opposite ends, being both cylindrical surfaces concentrically with a sleeve axis; and said printing facility comprising:
a printing machine comprising a central drum and a plurality of printing units, each printing unit integrating at least one printing shaft which provides a sleeve support;
a robotic unit comprising a sleeves handling device;
   the method include following steps:
displacing the robotic to emplace the sleeves handling device adjacent to the sleeve axis of a printing assembly stored on a first storage;
   said printing sleeve assembly being composed by a printing sleeve having a cylindrical internal surface with a diameter larger than the diameter of the shaft of said printing shaft and an independent tubular cylindrical intermediate sleeve inserted into the cylindrical printing sleeve, said intermediate sleeve having an internal cylindrical surface providing a gap fitting with the printing shaft, an external cylindrical surface with a diameter equal than the diameter of the printing sleeve internal surface,
   said printing sleeve being immobilized in the first storage through a retaining elements in geometrical interference with the printing cylindrical external surface and/or with at least one of the annular faces of the printing sleeve;
coupling the sleeves handling device of the robotic unit to the intermediate sleeve of the sleeve assembly stored and immobilized on the first storage;
produce an extraction of the intermediate sleeve coupled to the sleeve handling device from the printing sleeve stored on the printing sleeve storage through the intermediate sleeve displacement along an extraction path parallel to the sleeve axis through the robotic unit activation, achieving a complete extraction of the intermediate sleeve.

Said method is reverse to the previous method described, allowing in this case the separation of a printing sleeve assembly stored on said printing sleeve storage by coupling the handling device of the robotic unit to the intermediate sleeve, and proceed to the extraction of said intermediate sleeve from the printing sleeve, which is immobilized in the printing sleeve storage by the retaining elements.

In addition this method can be also applied by a robotic unit including a handling shaft in cantilever with a diameter equal or smaller than the printing shaft diameter, and said step of displacing the robotic unit to emplace the sleeves handling device adjacent to the sleeve axis of a printing assembly stored on a first storage will include:
placing said handling shaft of the robotic unit aligned with the sleeve axis of the printing sleeve assembly stored on the first storage, being the cantilevered end of the handling shaft adjacent to the annular face of the printing sleeve assembly stored;
   and said step of coupling the sleeves handling device of the robotic unit to the intermediate sleeve of the sleeve assembly stored and immobilized on the first storage will include:
insert said handling shaft of the robotic unit into the internal cylindrical surface of the intermediate sleeve of the printing sleeve assembly through the robotic unit displacement along a path parallel to the sleeve axis; and/or
gripping a handle of the intermediate sleeve placed on the annular face of said intermediate sleeve through a gripping means emplaced on a handling device carriage slidably arranged on said handling shaft for a driven displacement along said handling shaft.

It will be understood that references to geometric position, such as parallel, perpendicular, tangent, etc. allowed deviations up to ±5° from the theoretical position defined by the nomenclature.

Other features of the invention appear from the following detailed description of an embodiment.

### BRIEF DESCRIPTION OF THE DRAWING

The foregoing and other advantages and features will be better understood from the following detailed description of an embodiment with reference to the accompanying drawings, to be taken as illustrative and not limiting, in which:

FIG. 1 shows a schematic view of the disclosed facility, including a printing machine with six printing units or printing groups with six printing shafts carrying in this embodiment six printing sleeves assemblies surrounding a central drum; a robotic unit including a base, a first segment, a second segment and a sleeves handling device which comprises a handling shaft and a carriage with gripping means; a first storage with three overlapped levels including protruding retaining elements, the lower level storing a printing sleeve assembly, the intermediate lever storing a printing sleeve, and the upper lever being empty; and said facility also including a second storage with three overlapped levels including storing shafts the lower lever storing a printing sleeve assembly, the intermediate level storing an intermediate sleeve and the upper level being empty; in this view, the sleeves handling device of the robotic unit is empty and aligned with one printing shaft;

FIG. 2 is equivalent to FIG. 1, but illustrates a printing sleeve assembly supported on the handling shaft of the robotic unit after having been extracted from a printing shaft;

FIG. 3 is equivalent to FIG. 2, but illustrates the printing sleeve assembly connected to the handling shaft of the robotic unit with said printing sleeve assembly stored in the printing sleeve storage;

FIG. 4 is equivalent to FIG. 3, but illustrates the printing sleeve of the sleeve assembly stored in the first storage and the intermediate sleeve after having been disassembled, being the printing sleeve retained in the first storage, and being the intermediate sleeve connected to and supported by the handling shaft of the robotic unit.

FIGS. 5a and 5b show an alternative embodiment of the first storage being the support surface a cylindrical support surface, and an alternative embodiment of the retaining elements being an inflatable pillow;

FIGS. 6a and 6b show an alternative embodiment of the first storage being the support surface a U-shaped support surface, and an alternative embodiment of the retaining elements being activated jaws;

FIGS. 7a and 7b show an alternative embodiment of the first storage being the support surface an U-shaped support surface, and an alternative embodiment of the retaining elements being protruding elements facing the annular face of the printing sleeve with adjustable high.

### DETAILED DESCRIPTION OF EMBODIMENTS

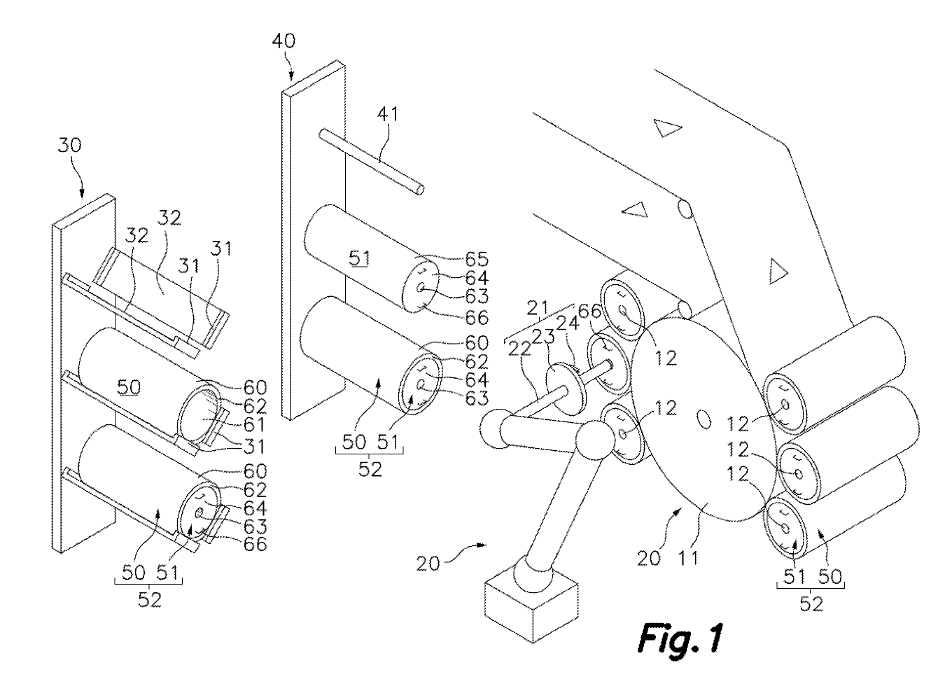

FIG. 1 shows a schematic view of a preferred embodiment, with a non-limitative character, of a printing facility including:
a printing machine 10 comprising a central drum 11 and a plurality of printing units, each printing unit integrating at least one printing shaft 12 which provides a sleeve support (for a sleeve assemblies 52, in this example);
a robotic unit 20 comprising a sleeves handling device 21;
   Said FIG. 1 also shows a plurality of sleeve assemblies 52 in interaction with said printing facility, being each printing assemblies 52 composed by:
a printing sleeve 50 having a printing cylindrical external surface 60, a cylindrical internal surface 61 with a diameter larger than the diameter of the shaft of said printing shaft 12, two annular faces 62 on two opposite ends, being both cylindrical surfaces 60, 61 concentric with a sleeve axis, and
an independent tubular cylindrical intermediate sleeve 51 inserted into the cylindrical printing sleeve 50, said intermediate sleeve 51 having an internal cylindrical surface 63 providing a gap fitting with the printing shaft 12, an external cylindrical surface 65 with a diameter equal than the diameter of the internal surface 61 of the printing sleeve, and two annular faces 64 on two opposite ends, being all the cylindrical surfaces 65, 63, 61, 60 of the printing assembly 52 concentric with a sleeve axis and said sleeve supports being provided for coupling with the intermediate sleeve 51 and/or with the printing sleeve assembly 52;

The disclosed printing facility includes:
a first storage 30 for storing a plurality of printing sleeves assemblies 52 or printing sleeves 50, said first storage 30 being provided with a retaining elements 31 for the immobilization of the printing sleeves 50 stored on said first sleeves storage 30 in geometrical interference with the printing cylindrical external surface 60 and/or with at least one of the annular faces 62 of the printing sleeve 50, said retaining elements 31 being disposed avoiding a geometrical interference with a displacement path in the sleeve axis direction of an intermediate sleeve 51 to be extracted or to be inserted into the printing sleeve 50 of a sleeve assembly 52, being the printing sleeve 50 stored on said first storage 30.

Said first storage 30 include for each printing sleeve 50 at least two symmetrical convergent flat support surfaces 32 defining a concave support for retaining by gravity a printing sleeve 50 and providing a geometrical interference with the printing cylindrical external surface 60 of the printing sleeve 50 whatever its diameter. In this embodiment the support surfaces 32 are inclined 45° regarding the vertical position, as shown on FIGS. 1, 2, 3 and 4.

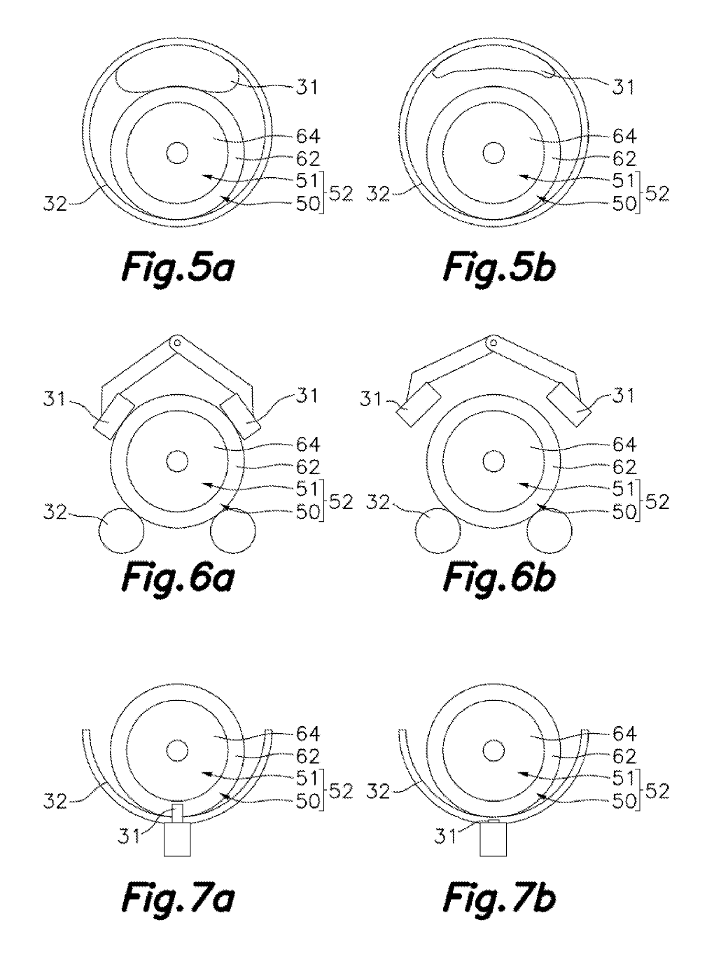

According to an alternative embodiment shown in FIGS. 5a and 5b said first storage 30 include for each printing sleeve 50 a cylindrical hollow wall with a diameter bigger than the diameter of the printing sleeve to be stored therein.

Another alternative embodiment is shown in FIGS. 7a and 7b. Said embodiment of the first storage 30 includes, for each printing sleeve 50, a concave wall, for example a U-shaped wall, provided for retaining therein the printing sleeve 50 by gravity.

An additional alternative embodiment is shown in FIGS. 6a and 6b. Said embodiment of the first storage 30 includes, for each printing sleeve 50, two symmetrical curved support surfaces 32 defining a concave support for retaining by gravity a printing sleeve 50 and providing a geometrical interference with the printing cylindrical external surface 60 of the printing sleeve 50 whatever its diameter. In this embodiment said two symmetrical curved support surfaces 32 are two spaced and parallel cylinders.

The retaining element 31 of the embodiment shown in FIGS. 1 a 4 is an element protruding from at least one of the support surfaces 32, facing the annular face 62 of the printing sleeve 50, said protruding element 31 protruding a distance smaller than the thickness of a printing sleeve 50 stored on said supporting surfaces 32. This protruding element retains the printing sleeve 50 during the extraction in the sleeve axis direction of an intermediate sleeve 51 tightly inserted into said printing sleeve 50 for constituting a sleeve assembly 52.

FIGS. 5a and 5b shown an alternative embodiment of the retaining element 31, wherein said retaining element 31 is an inflatable pillow which, in inflated position (FIG. 5a), presses the external cylindrical printing surface of the stored printing sleeve 50 producing its immobilization, and which in deflated position (FIG. 5b) break free the printing sleeve 50. Said inflatable pillow will be connected to an air compressor, or to a pressured fluid pipe, and a automatic valve will control and activate the inflation and deflation of said inflatable pillow.

FIGS. 6a and 6b shown another alternative embodiment of the retaining element 31, wherein said retaining element 31 are jaws surrounding, in closed position (FIG. 6a), the external cylindrical printing surface of the stored printing sleeve 50 producing its immobilization, and which can be opened in order to break free said printing sleeve 50. Said activated jaws will be activated, for example, by an electric motor, a piston, a servomotor, or similar.

FIGS. 7a and 7b shown an additional alternative embodiment of the retaining element 31, wherein said retaining element 31 are protruding elements facing the annular face of the printing sleeve 50, said protruding elements having adjustable high. The protruding elements interfere and prevent the extraction of the printing sleeve 50 in the axial direction. The high of said protruding element can be adjusted, for example, by an electric motor, a piston, a servomotor, or similar.

The robotic unit 20 is, in the example shown in FIGS. 1 to 4, a robotic arm with a base, a first segment articulated to the base with a two freedom axis, a second segment articulated to the first segment with a two freedom axis, and a sleeve handling device 21 articulated to the second segment with a two freedom axis. In this embodiment, the sleeve handling device 21 is a cylindrical handling shaft 22 in cantilever having a diameter equal or smaller than the printing shaft 12 diameter, in combination with a gripping means 24 connected to a carriage 23 slidably arranged along said handling shaft 22. Said gripping means 24 can grip a handle 66 placed on the annular face 64 of the printing sleeve assembly 52 or on the annular face of the intermediate sleeve 51, and the carriage 23 can be driven along the handling shaft 22 pushing or pulling the gripped printing sleeve 50 or intermediate sleeve 51 producing the insertion or extraction of the handling shaft 22 in said printing or intermediate sleeve 51.

Optionally the facility can include an second storage 40 with a plurality of cylindrical storage shafts 41 with equal diameter than the printing shafts 12, said storage shafts 41 being used to store intermediate sleeves 51 or printing sleeves assemblies 52, or even printing sleeves 50 having an internal cylindrical surface 61 with a diameter providing a gap fitting with the printing shaft 12.

Using this facility two alternative methods are also disclosed, a first method is provided for the automatic assembly of a printing sleeve 50 with an intermediate sleeve 51 creating a printing sleeve assembly 52, using the robotic unit 20 and the first storage 30.

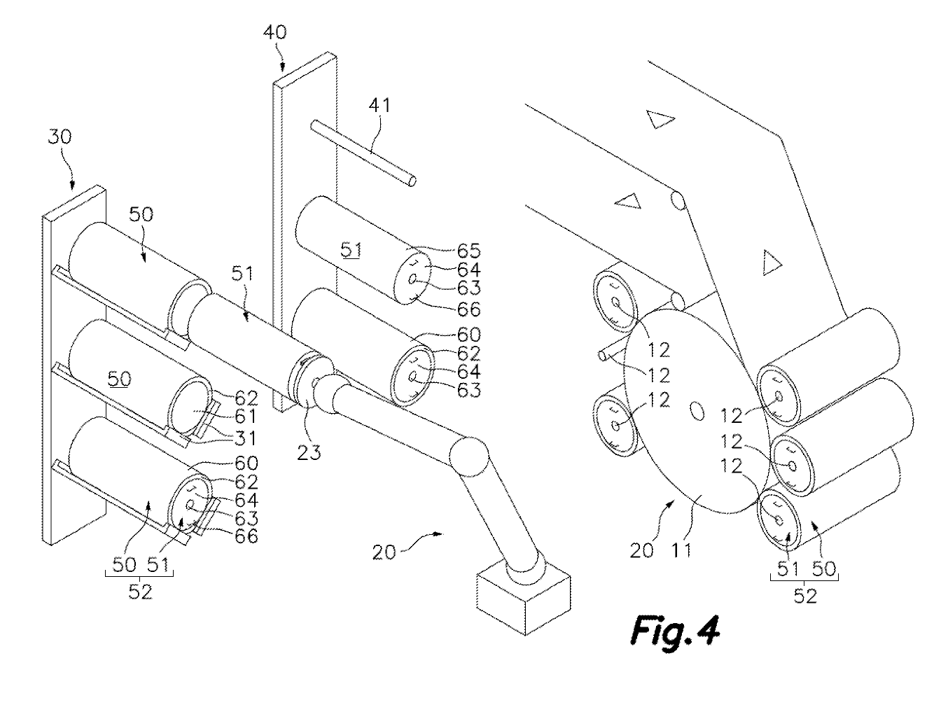

According said first method, and using the above described non-limitative embodiment of a facility, the handling shaft 22 of the robotic unit 20 carries an intermediate sleeve 51, and the robotic unit 20 is activated to displace and orient the handling shaft 22 in order to situate the intermediate sleeve axis of the carried intermediate sleeve 51 aligned with the sleeve axis of a printing sleeve 50 stored on the first storage 30. Said stored printing sleeve 50 is immobilized on the printing sleeve storage 30 by its geometrical interaction of its annular faces 62 with said retaining elements 31, in this case the protruding elements. This step can be shown on FIG. 4.

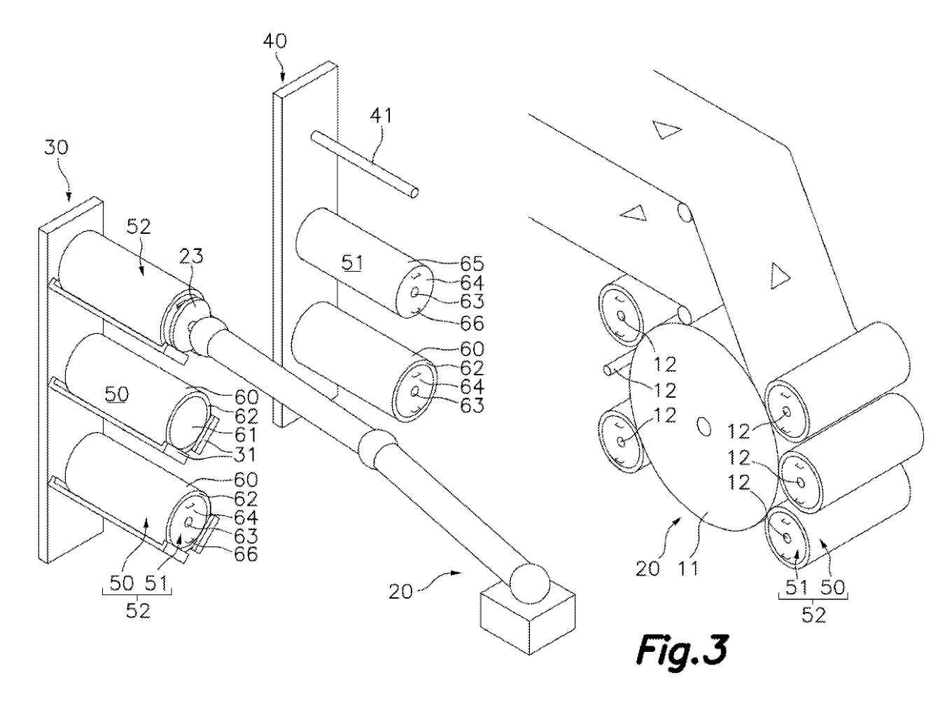

After that the robotic unit 20 is activated to displace the carried intermediate sleeve 51 along an insertion path parallel to the sleeve axis, producing the introduction of said intermediate sleeve 51 into the stored and positionally retained printing sleeve 50, creating a printing sleeve assembly 52 (see FIG. 3).

After that the printing sleeve assembly 52 can be disconnected from the robotic unit 20, producing the extraction of the handling shaft 22, for example by the robotic unit 20 displacement in a direction reverse to the insertion path after the release of the gripping means 24, producing the extraction of the handling shaft 22 from the sleeve assembly 52.

Optionally this operation can be performed in combination with the displacement of the carriage 23 connected with the gripping means 24 at the same time and identic velocity than the robotic unit 20 displacement but in the insertion path direction in order to avoid the extraction of the intermediate sleeve 51 from the printing sleeve 50 during said operation, and leaving the printing sleeve assembly 52 assembled and stored, and the sleeves handling device 21 disconnected from said printing sleeve assembly 52.

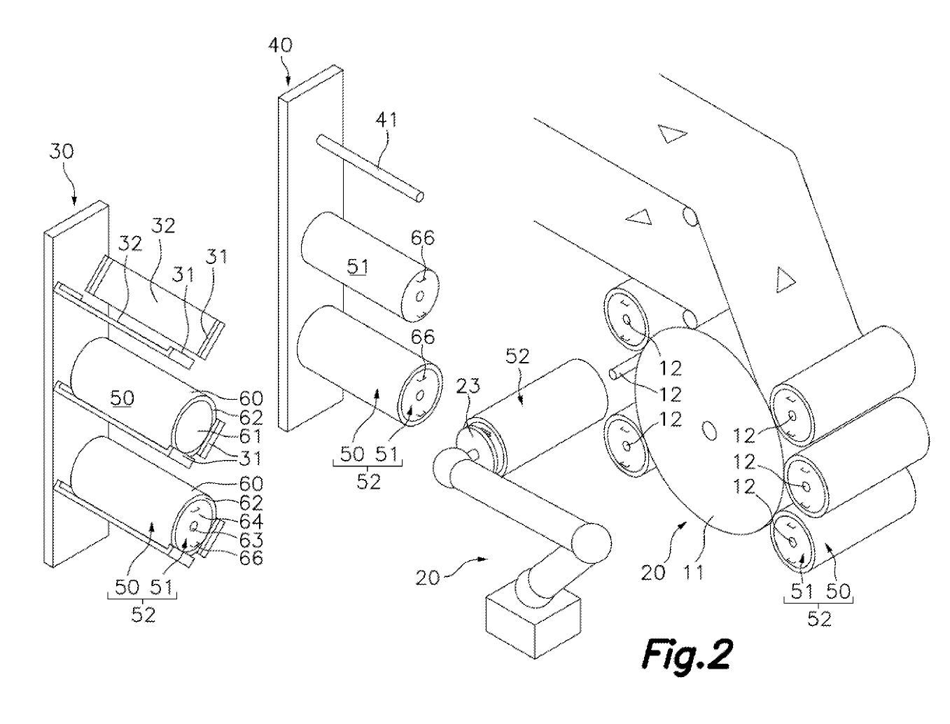

Alternatively to the disconnection of the robotic unit 20 from the sleeve assembly 52, after the coupling operation the robotic unit 20 can elevate the printing sleeve assembly 52 releasing it from its geometric interference with the first storage 30 and from the retaining elements 31, and after that displace the robotic unit 20 to transfer said printing sleeve assembly 52 to an empty printing shaft 12 (see FIGS. 2 and 1) or to an empty storing shaft 41 of the second storage 40.

The second method describes a reverse operation for decoupling the printing sleeve assembly 52 separating the intermediate sleeve 51 from the printing sleeve 50. This operation starts with a printing sleeve assembly 52 stored on the first storage 30, then the handling shaft 22 of the robotic unit 20 is aligned with the sleeve axis of said stored printing sleeve assembly 52.

Then the robotic unit 20 is activated to displace said handling shaft 22 in a direction parallel to the sleeve axis producing its insertion into the intermediate sleeve 51 integrated on said printing sleeve assembly 52 (see FIG. 3). Once the handling shaft 22 is inserted, the gripping means 24 of the sleeves handling device 21 are connected to a handle 66 located on the annular face 64 of the intermediate sleeve 51, and then the robotic unit 20 is activated to displace the handling shaft 22 and the sleeves handling device 21 in an extraction path parallel to the sleeve axis. The printing sleeve of the printing sleeve 50 assembly rests immobilized in the first storage 30 through the retaining elements 31, and the intermediate sleeve 51 is extracted from the printing sleeve 50 conjointly with the handling shaft 22. After the total extraction of the intermediate sleeve 51, this intermediate sleeve 51 can be inserted into another printing sleeve 50 stored in the first storage 30, or it can be stored in a storing shaft 41 of the second storage 40.

The robotic unit includes air ducts provided for its connection with an intermediate sleeve 51 supported by said robotic unit 20 and for insufflating air into said intermediate sleeve 51 through at least one air entrance, located on one annular face 64 of the intermediate sleeve 51. Said at least one air entrance is connected to a sleeve air ducts embedded on said intermediate sleeve 51, said sleeve air ducts being connected to a plurality of air exits placed on the external cylindrical surface 65 of the intermediate sleeve 51.

During the operation of inserting or extracting the intermediate sleeve to or from the printing sleeve, an air supply is insufflated from the air ducts of the robotic unit 20 into the at least one air entrance of the intermediate sleeve 51, passing through the sleeve air ducts and exiting through said air exits. This air exiting from the air exits is injected into the interspace or gap existing between the external cylindrical surface 65 of the intermediate sleeve and at least part of the internal cylindrical surface 61 of the printing sleeve 50, being the intermediate sleeve 51 at least partially inserted into said printing sleeve 50. This air injected in said interspace produce an air sheet which facilitates a smooth displacement of the intermediate sleeve 51 regarding the printing sleeve 50.

Optionally the internal cylindrical surface of the printing sleeve being can be made of an elastic material, in such a way that the pressure of the air injected into said interspace deform said elastic material producing a slight increase of the diameter of the internal cylindrical surface 61 of the printing sleeve 50.

In an alternative embodiment, the handling shaft 22 of the robotic unit 20 includes fixing means which produce its expansion when it is inserted into the intermediate sleeve 51. In this alternative embodiment said fixing means can substitute the gripping means.

While along the description particular reference has been done to how an intermediate printing sleeve 51 is inserted to or extracted from a printing sleeve assembly 52 by using a first sleeves storage 30 and a robotic unit 20, it should be understood that both the facility and the method also encompass the handling of a printing sleeve assembly 52 to be transported and installed to a printing unit or to a first sleeve storage 30 or to a second sleeves storage 40, as well as the setting-up of the sleeves to a printing unit or removal therefrom.

1. Printing facility for manipulation of a plurality of tubular and cylindrical shaped sleeves each including a cylindrical external surface, a cylindrical internal surface and two annular faces on two opposite ends, being both cylindrical surfaces concentrically with a sleeve axis;
said printing facility comprising:
a printing machine comprising a central drum and a plurality of printing units, each printing unit integrating at least one cylindrical printing shaft which provides a sleeve support;
a robotic unit comprising a sleeves handling device;
wherein the facility is provided for manipulation of:
sleeve assemblies each composed by a printing sleeve having a cylindrical internal surface with a diameter larger than the diameter of said printing shaft and an independent tubular cylindrical intermediate sleeve inserted into the cylindrical printing sleeve, said intermediate sleeve having an internal cylindrical surface with a diameter providing a gap fitting with the printing shaft, having an intermediate sleeve external cylindrical surface with a diameter equal than the diameter of the printing sleeve internal surface, and two annular faces on two opposite ends, being all the cylindrical surfaces of the printing assembly concentric with a sleeve axis;
said printing facility further comprising:
a first storage for store a plurality of printing sleeves, said first storage being provided with a retaining elements for the immobilization of the stored printing sleeves in geometrical interference with the printing cylindrical external surface and/or with at least one of the annular faces of the printing sleeves, said retaining elements being disposed avoiding a geometrical interference with a displacement path in the sleeve axis direction of an intermediate sleeve to be extracted or to be inserted into the printing sleeve, being the printing sleeve stored on said printing sleeve storage.

2. Printing facility according to claim 1 wherein said first storage include for each printing sleeve at least two convergent support surfaces defining a concave support for retaining by gravity a printing sleeve by geometrical interference with the printing cylindrical external surface of said printing sleeve whatever its diameter.

3. Printing facility according to claims 2 wherein said retaining elements are defined by at least a protrusion protruding from said concave support facing the annular surface of a printing sleeve stored on said concave support.

4. Printing facility according to claim 1 wherein said retaining elements are selected among:
an inflatable pillow pressing the external cylindrical printing surface of the stored printing sleeve producing its immobilization; or
activated jaws surrounding the external cylindrical printing surface of the stored printing sleeve producing its immobilization; or
protruding elements facing the annular face of the printing sleeve with adjustable high.

5. Printing facility according to claim 2 wherein said retaining elements are selected among:
an inflatable pillow pressing the external cylindrical printing surface of the stored printing sleeve producing its immobilization; or
activated jaws surrounding the external cylindrical printing surface of the stored printing sleeve producing its immobilization; or
protruding elements facing the annular face of the printing sleeve with adjustable high.

6. Printing facility according to claim 1 wherein the robotic unit include a handling shaft in cantilever with a diameter equal or smaller than the printing shaft.

7. Printing facility according to claim 6 wherein the handling device of the robotic unit include a gripping means connected to a carriage which is slidably arranged on said handling shaft for a driven displacement along said handling shaft.

8. Printing facility according claim 6 wherein said handling shaft include a fixing device for the fixation of an intermediate sleeve supported on said handling shaft.

9. Printing facility according to claim 1 wherein the facility include an second storage which can store a plurality of intermediate sleeves, and/or a plurality of sleeve assemblies, each supported on a storage shaft.

10. Printing facility according to claim 1 wherein the robotic unit include air ducts provided for its connection with at least one air entrance provided in one annular face of the intermediate sleeve supported by said robotic unit, said air entrance being connected with an sleeve air duct embedded into the intermediate sleeve, said sleeve air duct being connected with a plurality of air exits placed on the external cylindrical surface of the intermediate sleeve, and said air ducts being provided for insufflating air through said air exits.

11. Printing facility according to claim 1 wherein the said first storage include, for each stored printing sleeve, at least a concave surface with a constant cross section along the length thereof for retaining by gravity a printing sleeve by geometrical interference with the printing cylindrical external surface of said printing sleeve whatever its diameter.

12. Printing facility according to claim 1 wherein the said first storage include, for each stored printing sleeve, at least two convex symmetric surfaces each with a constant cross section along the length thereof for retaining by gravity a printing sleeve by geometrical interference with the printing cylindrical external surface of said printing sleeve whatever its diameter.

13. Method for sleeves arrangement in a printing facility said sleeves being a plurality of tubular and cylindrical shaped sleeves each including a cylindrical external surface, a cylindrical internal surface and two annular faces on two opposite ends, being both cylindrical surfaces concentric with a sleeve axis, and said printing facility comprising:
a printing machine comprising a central drum and a plurality of printing units, each printing unit integrating at least one printing shaft which provides a sleeve support;
a robotic unit comprising a sleeves handling device;
wherein the method include following steps:
displacing the robotic unit, having an intermediate sleeve coupled to the sleeve handling device, to align an intermediate sleeve axis of said intermediate sleeve with the sleeve axis of a printing sleeve stored on a printing sleeve storage;
said printing sleeve having a cylindrical internal surface which diameter is bigger than the diameter of the printing shafts;
said intermediate sleeve having an internal cylindrical surface with a diameter providing a gap fitting with the printing shafts, an external cylindrical surface with a diameter equal than the diameter of the internal cylindrical surface of the stored printing sleeve and two annular faces on two opposite ends, being both cylindrical surfaces concentric with said intermediate sleeve axis;
said printing sleeve being immobilized in the first storage through a retaining elements in geometrical interference with the printing cylindrical external surface and/or with at least one of the annular faces of the printing sleeve;
producing an insertion of the intermediate sleeve coupled to the sleeve handling device into the printing sleeve stored on the printing sleeve storage through the displacement of the intermediate sleeve along an insertion path parallel to the sleeve axis through the robotic unit activation, achieving a complete insertion of the intermediate sleeve into the printing sleeve obtaining a printing assembly.

14. Method according to claim 13 wherein the robotic unit include a handling shaft in cantilever with a diameter equal or smaller than the diameter of the printing shafts, wherein said step of displacing the robotic unit having an intermediate sleeve coupled to the sleeve handling device to align an intermediate sleeve axis of said intermediate sleeve with the sleeve axis of a printing sleeve stored on a printing sleeve storage include:
placing said handling shaft of the robotic unit aligned with the sleeve axis of the printing sleeve stored on the first storage, being the cantilevered end of the handling shaft adjacent to the annular face of the stored printing sleeve;
and wherein said step of producing an insertion of the intermediate sleeve coupled to the sleeve handling device into the printing sleeve stored on the printing sleeve storage include:
insert said handling shaft of the robotic unit, and the intermediate sleeve carried on said handling shaft, into the internal cylindrical surface of the stored printing sleeve through the robotic unit displacement along an insertion path parallel to the sleeve axis.

15. Method according to claim 13 wherein after the insertion step, the printing sleeve assembly is extracted from the printing sleeve storage through the robotic unit activation, releasing the printing cylindrical external surface of the printing sleeve from the geometrical interference with the retaining elements of the first storage.

16. Method according to claim 13 wherein the intermediate sleeve coupled to the sleeves handling device has been coupled to said sleeves handling device with a method selected among:
emplacing an empty sleeves handling device adjacent to an intermediate sleeve stored in a sleeves storage, coupling the sleeves handling device with the intermediate sleeve and extracting the intermediate sleeve from the sleeve storage; or
emplacing a sleeve assembly coupled to a sleeves handling device in a printing sleeve storage being the printing sleeve, constitutive of said printing sleeve assembly, immobilized in the first storage through said retaining elements in geometrical interference whit the printing cylindrical external surface and/or with at least one of the annular faces of the printing sleeve, and produce the extraction of the intermediate sleeve coupled to the sleeve handling device from the printing sleeve retained on the printing sleeve storage through the displacement of the intermediate sleeve along an extraction path parallel to the sleeve axis through the robotic unit activation.

17. Method for printing sleeves arrangement in a printing facility, said printing sleeves being a plurality of tubular and cylindrical shaped printing sleeves each including a printing cylindrical external surface , a cylindrical internal surface (61) and two annular faces on two opposite ends, being both cylindrical surfaces concentric with a sleeve axis; said printing facility comprising:
a printing machine comprising a central drum and a plurality of printing units, each printing unit integrating at least one cylindrical printing shaft which provides a sleeve support;
a robotic unit comprising a sleeves handling device;
wherein the method include following steps:
displacing the robotic unit to emplace the sleeves handling device adjacent to the annular face of a printing assembly stored on a first storage;
said printing sleeve assembly being composed by a printing sleeve having a cylindrical internal surface with a diameter larger than the diameter of said printing shaft and an independent tubular cylindrical intermediate sleeve inserted into the printing sleeve, said intermediate sleeve having an internal cylindrical surface with a diameter providing a gap fitting with the printing shaft, an external cylindrical surface with a diameter equal than the diameter of the internal surface of the printing sleeve,
said printing sleeve being immobilized in the first storage through a retaining elements in geometrical interference with the printing cylindrical external surface and/or with at least one of the annular faces of the printing sleeve;
coupling the sleeves handling device of the robotic unit to the intermediate sleeve of the sleeve assembly that is stored and immobilized on the first storage;
produce an extraction of the intermediate sleeve, coupled to the sleeve handling device, from the printing sleeve stored on the printing sleeve storage through the intermediate sleeve displacement along an extraction path parallel to the sleeve axis through the robotic unit activation, achieving a complete extraction of the intermediate sleeve.

18. Method according to claim 17 wherein the robotic unit include a handling shaft in cantilever with a diameter equal or smaller than the diameter of the printing shaft, wherein said step of displacing the robotic unit to emplace the sleeves handling device adjacent to the sleeve axis of a printing assembly stored on a first storage include:
placing said handling shaft of the robotic unit aligned with the sleeve axis of the printing sleeve assembly stored on the first storage, being the cantilevered end of the handling shaft adjacent to the annular face of the printing sleeve assembly stored;
and wherein said step of coupling the sleeves handling device of the robotic unit to the intermediate sleeve of the printing sleeve assembly stored and immobilized on the first storage include:
insert said handling shaft of the robotic unit into the internal cylindrical surface of the intermediate sleeve of the printing sleeve assembly through the robotic unit displacement along a path parallel to the sleeve axis; and/or
gripping a handle of the intermediate sleeve placed on the annular face of said intermediate sleeve through a gripping means emplaced on a handling device carriage slidably arranged on said handling shaft for a driven displacement along said handling shaft.
